(19) United States
(12) Patent Application Publication
(10) Pub. No.: US 2017/0239667 A1
(43) Pub. Date: Aug. 24, 2017

(54) MACERATOR FOR UTILISATION OF HOSPITAL WASTE, IN PARTICULAR CELLULOSE PULP

(71) Applicant: OPP Sp. z.o.o., Poznan (PL)

(72) Inventor: Kamila HOFMAN, Poznan (PL)

(21) Appl. No.: 15/514,298

(22) PCT Filed: Sep. 28, 2015
(86) PCT No.: PCT/PL2015/000154

§ 371 Date: Mar. 24, 2017

(30) Foreign Application Priority Data
Sep. 29, 2014 (PL) P.409621
Sep. 29, 2014 (PL) P.409622
Sep. 29, 2014 (PL) P.409623

(51) Int. Cl. B02C 18/00; B02C 18/22; B09B 3/00; B02C 18/12

(52) U.S. Cl. CPC B02C 18/0092; B02C 18/12; B02C 18/2216; B09B 3/0075

(57) ABSTRACT

A macerator is disclosed for utilisation of hospital waste, in particular cellulose pulp, to be used in hospitals, nursing homes and other facilities which require the utilisation ofhygiene products such as diapers, disposable paper bed sheets and other personal hygiene products, such as cellulose-base urinals and bedpans with their contents, that is, excreta. In the bottom zone a truncated cone shape grinder is placed, with slots separating the charge chamber from the discharge chamber, whereas on the motor axis a plate is located, bent at the end in parallel to the grinder surface, with slots in the bend, and moreover on the plate on the charge chamber side at least two shaped grinding knives are located, and within its end zone at least two squeezers, whereas under the plate from the discharge chamber side at least two scrapers are installed.

The subject of the invention is a macerator for utilisation of hospital waste, in particular cellulose pulp, to be used in hospitals, nursing homes and other facilities which require the utilisation of hygiene products such as diapers, disposable paper bed sheets and other personal hygiene products, such as cellulose-base urinals and bedpans with their contents, that is, excreta.

So far the utilisation of such disposable products was performed by using devices which grind them with their contents with water. These devices have a closed grinding chamber with a shredding knife powered with an electrical motor. The grinding chamber is connected by a discharge valve to the sewage system. A water tank is connected to the grinding chamber, supplied from the domestic water system. The necessary amount of water from the tank is supplied to the grinding chamber using a water pump. The water enters the grinding chamber through a sprinkler in the grinding chamber cover. After closing the grinding chamber cover, which is previously filled with used disposable hygiene products a working cycle starts. This cycle is started by a water pump by feeding water from a tank through the sprinkler to the grinding chamber.

After filling with water the shredding knife is switched on. Before the grinding is finished the contents are diluted by adding water, which facilitates the flushing of contents to the sewage system. After the ground pulp is flushed from the grinding chamber the washing of the grinding chamber is sometimes performed. For this purpose the sprinkler is used to supply water which washes the internal surfaces of the chamber and cover. The water flows out through the open discharge valve.

The GB1209766 British patent demonstrates a known apparatus for the grinding and removal of waste. The device is used for grinding of, in particular, disposable paper sanitary vessels with streams of water. Water is supplied to the chamber and enters a rotor placed on the chamber bottom, flowing through holes in the rotor towards the rotor circumference in order to break up the material within the chamber. The rotor, which may be placed in an eccentric manner, is in the form of a flat plate and is powered by a motor. The water is sucked into a pipe under the rotor from a tank located below the chamber. The rotor may have vanes on the upper and lower surface. The chamber cover tightly seals the chamber. When the water pump operates the water is supplied to the chamber cover sealing groove, sealing the closed chamber. The cover is controlled by a pedal with a microswitch in the starter circuit, to prevent operating when the chamber is closed. The water pump may be used to assist the grinding rotor. After grinding the resulting pulp is discharged through a drain trap. The cover seal may be omitted if the device is used to grind non-contaminated materials.

The EP0347205 European patent demonstrates a macerator for the disposal of used sanitary products from paperboard, such as hospital urinals. The macerator has a housing closed with a cover, which is equipped with an internal spray nozzle. A rotating mixing knife is placed on the bottom of the casing, which has two cutting edges inclined at a different directions to the rotation axis? The mixing knife is placed asymmetrically within the casing. In particular the knife rotation axis may be inclined towards the casing's lengthwise axis. The casing has an opening for discharging the maceration products. The casing has a sloped base wall, above which the mixing knife is placed.

The EP1348816 European patent demonstrates a waste utilisation device, in which the chamber has an waste inlet, a macerated waste outlet, macerator, water inlet, flow control device and a macerator cutting disc with a drive. The device has independent drives of the water pump and of the macerator disc. The device's utilisation method consists of independent control of the flow of water and the operation of the macerator disc. The drives are switched on alternatively or simultaneously.

In the FR2812312 French patent the subject of the invention is a sanitary shredder in the wastewater and solid waste disposal system. The shredder has a chamber, electric motor, the axis of which has on its end an impeller pump with blades and shredding elements across the shredding chamber with an inlet hole. The front surface of the rotor is essentially flat and has multiple openings for the flow of water, placed essentially radially and directed towards the rotor circumference. Each hole in the rotor is extended by a channel restricted by the blade spirals, and the rotor is placed within the pump body in such a manner, as to ensure that its front surface is placed generally within the plane of the pump body opening. The shredding elements are placed on an axial projection in relation to the listed front surface. The shredding elements also include the circular cutting knife placed within the plane of the body opening and creating, along with the front surface of the rotor, the pump inlet opening.

In the known solutions of macerators, the water necessary to soften up the charge is supplied by a hose, with a stream directed on the charge. This solution does not enable the thorough wetting of the charge, which is necessary to conduct sufficient maceration. The air pressure increasing during the water supply process is released through an opening in the cover or through a one-way valve to the atmosphere, which reduces the comfort of personnel in the vicinity through the presence of contaminated air. Known macerators for utilisation of hospital waste, in particular cellulose pulp, have a body rigidly placed within the frame connected with a water supply system, a system connected with the sewage outlet, closed by a tight cover, and inside it knives for charge grinding placed on the axis of the electric motor.

Then the macerator operates, the body vibrates, which is transferred to the frame, causing frame vibrations which over a longer period result in the deterioration of the frame, increase the volume of harmful sounds, with a negative impact on the nearby personnel.

The essence of the invention, which is a macerator for the utilisation of hospital waste, in particular cellulose pulp, in the form of a tank connected to a water supply system, a system connected with the sewage system drain, closed with a tight cover, having inside knives for charge grinding placed on the axis of an electric motor, consist of having in the bottom zone a truncated cone shape grinder, with slots, separating the charge chamber from the discharge chamber, whereas on the motor axis a plate is located, bent at the end in parallel to the grinder surface, with slots in the bend, and moreover on the plate on the charge chamber side at least two shaped grinding knives are located, and within its end zone at least two squeezers, whereas under the plate from the discharge chamber side at least two scrapers are installed.

It is advantageous when the motor has a unit for changing the rotation speed and direction of rotation.

It is also advantageous when the plate is mounted on the motor axis using spacer rings.

It is also advantageous when the discharge chamber is connected to the sewage system.

Moreover it is advantageous when in the inner wall of the bowl-shaped cover, within its top zone from the inside of the macerator, it has a cavity connected with the water mains pipe by a valve, wherein in the cavity a water stream shape controller is placed on a threaded connection, with a mushroom-like shape with a shaped external surface and a shaped internal surface and a stem connected by a thread with the casing, whereas the controller has within the stem an internal tunnel connected with a pipe of the venting system.

Additionally it is advantageous, when the body of the macerator tank is placed on a frame of the casing on hangers, mounted each to the frame support through an elastic ring.

The use of the solution presented in the invention enables the following technical and utility effects:
the possibility of grinding a charge, in the form of waste formed of diapers, bedsheets and other soft containers with excreta inside, to a pulp,
the possibility of directly transferring the pulp to the sewage system using scrapers,
the possibility of adjusting the motor rotation depending on the type of charge,
the possibility of initial grinding of the charge by the grinding knives,
the possibility of thorough extrusion of ground charge by additional pressure of the charge through squeezers onto the grinding plate slots,
in case of an excessive amount of pulp in the discharge chamber—the possibility of changing the direction of motor rotation and moving the pulp with the scrapers until the outlet of sewage system is exposed,
elimination of contact with personnel after the macerator is closed and switched on,
the possibility of flushing and disinfecting the inside of the body after the utilisation process is finished,
the possibility of adjusting the pulp density by adjustment of the placement of the plate on the motor axis with the spacer rings, changing the distance between the plate and the grinder slots,
possibility of adding a bactericide agent to the pulp during the grinding process,
excellent wetting of the macerator charge through the creation of a bowl-shaped water film by the shape of the controller,
the possibility of shaping the liquid stream by adjusting the gap between the envelope surface of the controller and the socket edge,
the possibility of obtaining a permanent pressure inside the macerator by a venting tunnel connected to the sewage system,
preventing the spread of unpleasant odours by discharging them to the sewage system through a pipe,
maintenance-free,
damping of the macerator vibrations during operation,
significant silencing of the macerator operation,
stable positioning of the macerator in relation to the base,
the possibility of easy disconnection of macerator body from the frame facilitating the possibility of body replacement,
increasing the macerator durability,
facilitating the replacement of elastic damper rings,
low costs of manufacturing.

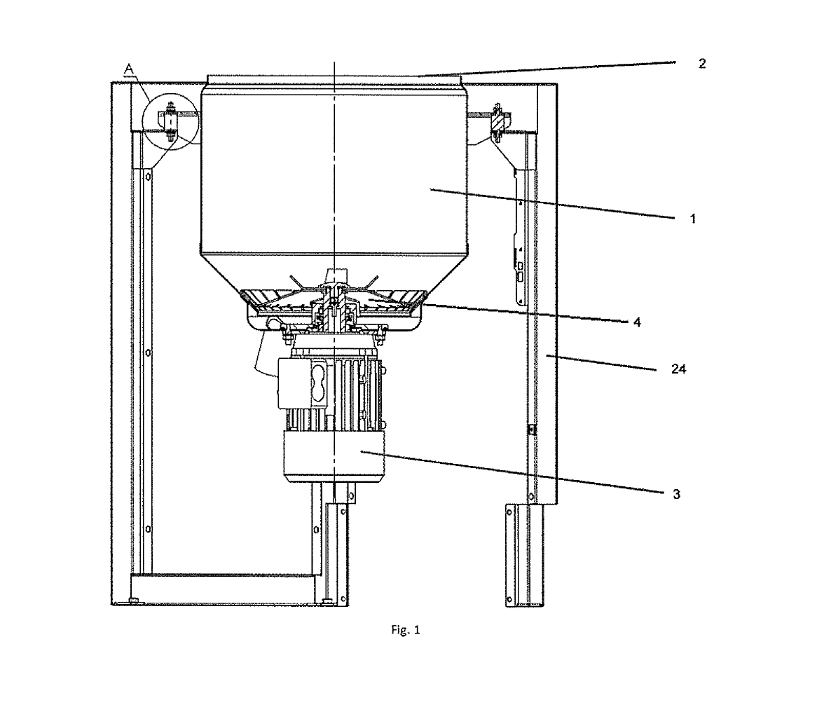

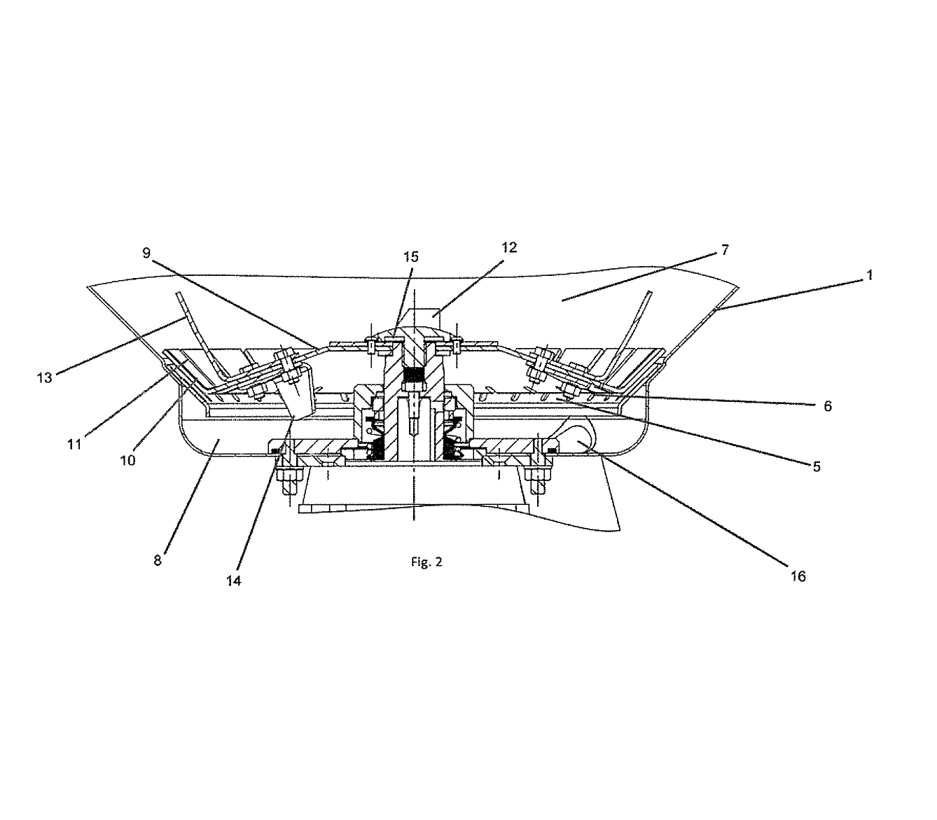

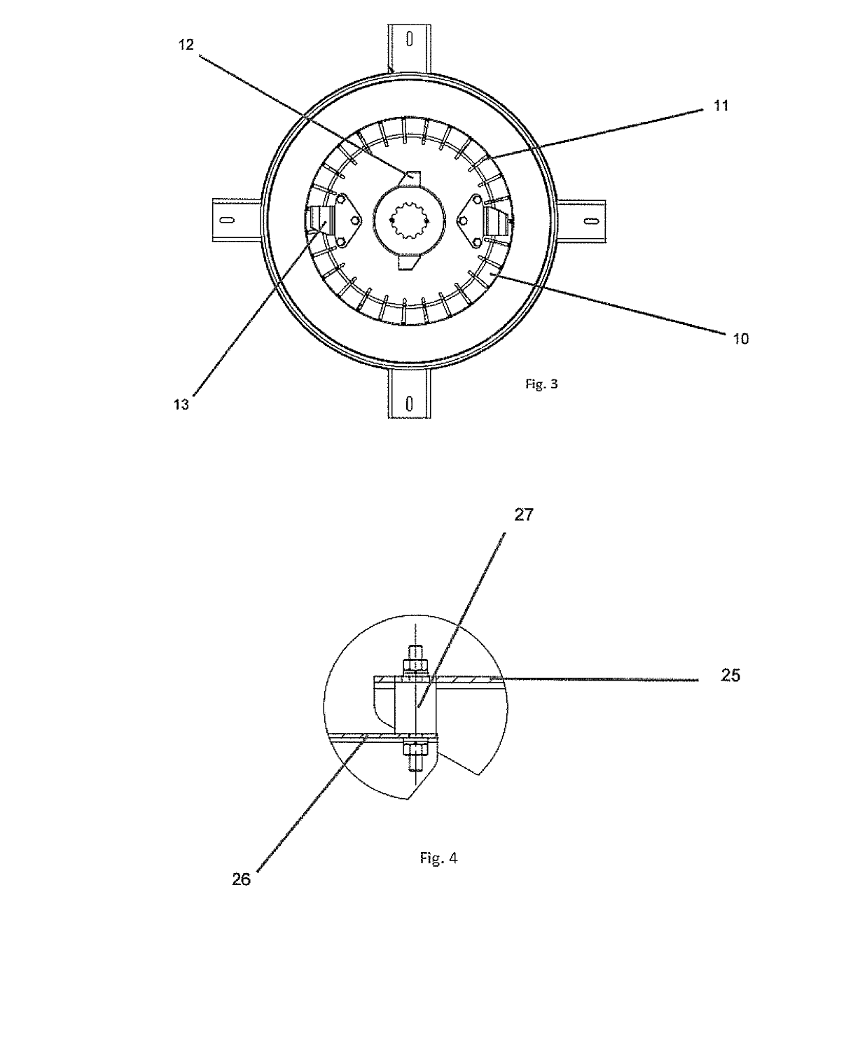

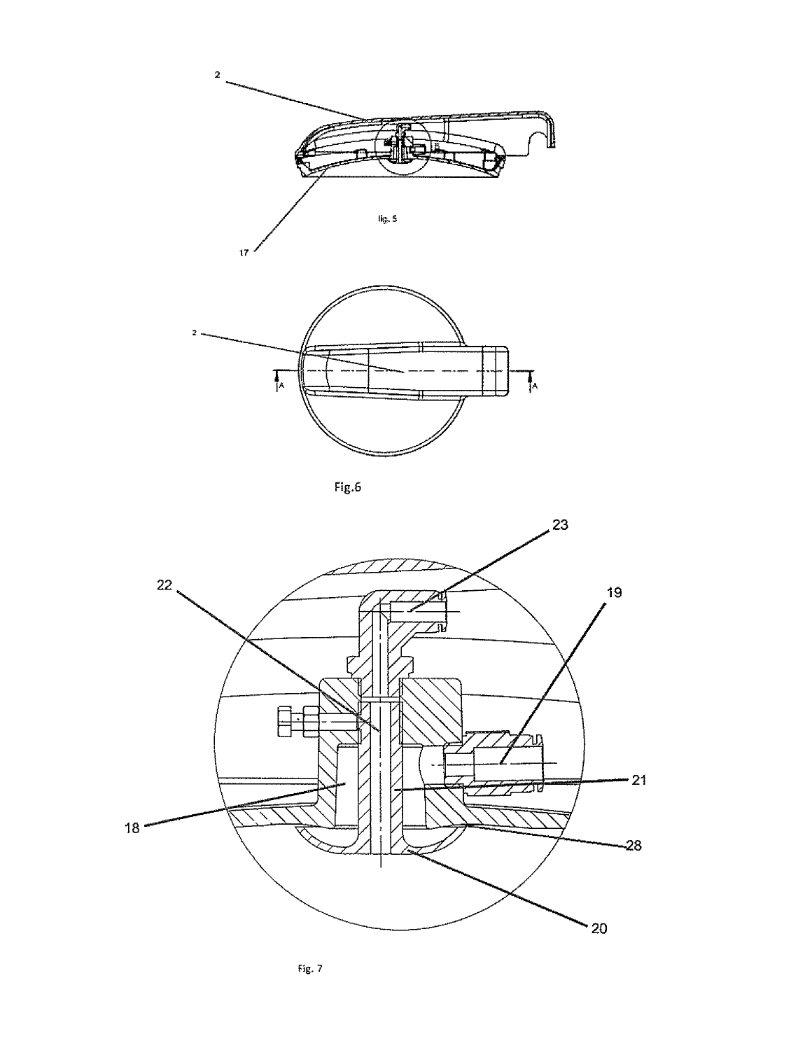

The subject of the invention, in an example, but not limiting, implementation was presented in diagrams on the figure, whereas on FIG. 1 the macerator was shown in a vertical cross section passing through its vertical axis, on FIG. 2 the grinding unit was shown in a vertical cross-section passing through its vertical axis, on FIG. 3 the unit was shown in a top view, on FIG. 4 the “A” detail from FIG. 1 was shown, on FIG. 5 the cover was shown in a vertical cross-section passing through the axis of the tunnel and the lengthwise axis of the cover arm, on FIG. 6 the cover was shown in a view of its external surface, whereas on FIG. 7 the “C” detail from FIG. 5 was shown.

The macerator for utilisation of hospital waste, in particular cellulose pulp, has a tank 1 rigidly connected with a water supply system, a system connected with the sewage outlet, not shown on the figure, closed by a tight cover 2. Inside it there's a charge grinding unit 4 placed on the axis of the electric motor 3. The charge grinding unit 4 has a truncated cone shape grinder 5 placed in the bottom zone of the tank 1, with radial slots 6. The grinder 5 separates the charge chamber 7 from the discharge chamber 8. The unit on the axis of the motor 3 has a placed plate 9, bent at the end in parallel to the grinder 5 surface, with radial slots 11 in the bend 10. On the plate 9 on the charge chamber 7 side at least two shaped grinding knives 12 are located, and within its end zone at least two squeezers 13. Under the plate 9 from the discharge chamber 8 side at least two scrapers 14 are installed.

There are versions where the motor 3 has a unit for changing the rotation speed and direction of rotation.

There are also versions, where the plate 9 is mounted on the motor 3 axis using spacer rings 15.

There are also versions, where the drain chamber 8 is connected with the sewage system outlet 16.

Moreover there are versions where in the inner wall 17 of the bowl-shaped cover 2, within its top zone from the inside of the macerator, there is a cavity 18 connected with the water mains pipe 19 by a valve, wherein in the cavity 18 a water stream shape controller 20 is placed on a threaded connection, with a mushroom-like shape with a shaped external surface and a shaped internal surface and a stem 21 connected by a thread with the casing, whereas the controller has within the stem 21 an internal tunnel 22 connected with a pipe 23 of the venting system.

Moreover there are versions where the body of the macerator tank 1 is placed on a frame 24 of the casing on hangers 25, mounted each to the frame 24 support 26 through an elastic ring 27.

The charge in the form of a diaper or another paper container with excreta is placed within the tank 1 of the macerator, the cover 2 is closed, the flow of water and disinfecting agents is started, and the motor 3 is started. The motor 3 speed is adjusted suitably to the quality of the charge in the tank 1. The plate 9 is started—it commences rotation. The grinding knives 12 located on perform impact shredding of the charge bulk into shreds. The centrifugal force moves the shreds towards the external zone of the plate 9. The squeezers 13 under the impact of centrifugal force press the shreds into the slots 11 of the bend 10 and press through the slots 6 of the grinder 5. The pulp created in this manner reaches the discharge chamber, where the scrapers 14 move it to the outlet 16 of the sewage system. The amount of ground mass is adjusted by the distance between the surface of the grinder 5 and the bend 10 of the plate 9 by placing an appropriate thickness spacer 15 on the motor 3 axis.

In the case when an excessive amount of ground mass accumulates within the discharge chamber 8, which may not be received by the sewage system, then it is possible to change the direction of motor 3 rotation. The scrapers 14, working in the opposite direction, will uncover the outlet 16 of the sewage system.

After the grinding is finished flushing and disinfection of the macerator with chemical agents is performed.

A batch of hospital waste is placed in the macerator. After the cover 2 is closed and sealed, a stream of water is directed inside the macerator. This stream is supplied by a pipe 19, with an outlet in the cavity 18. This stream under pressure passes onto an internal surface of the controller 20, where it changes the direction and passes through a slot 28 to an internal surface of the wall. A bowl-shaped stream of water is created, which gravitationally falls onto the entire surface of the charge, resulting in good wetting, which is necessary to conduct the maceration process.

The volume of the air which is reduced by the inflow of water into the macerator, along with unpleasant odours gets out through the tunnel 22 to the pipe 23 of the system.

The macerator tank vibrations are absorbed by an elastic ring 27.

1. Macerator for the utilisation of hospital waste, in particular cellulose pulp, in the form of a tank connected to a water supply system, a system connected with the sewage system drain, closed with a tight cover, having inside knives for charge grinding placed on the axis of an electric motor, wherein in the bottom zone a truncated cone shape grinder is placed, with slots, separating the charge chamber from the discharge chamber, whereas on the motor axis a plate is located, bent at the end in parallel to the grinder surface, with slots in the bend, and moreover on the plate on the charge chamber side at least two shaped grinding knives are located, and within its end zone at least two squeezers, whereas under the plate from the discharge chamber side at least two scrapers are installed.

2. Macerator in accordance with the claim 1, wherein the motor has a unit for changing the rotation speed and direction of rotation.

3. Macerator in accordance with the claim 1, wherein the plate is mounted on the motor axis using spacer rings.

4. Macerator in accordance with the claim 1, wherein the discharge chamber is connected with the sewage system.

5. Macerator in accordance with the claim 1, wherein the inner wall of the bowl-shaped cover, within its top zone from the inside of the macerator, it has a cavity connected with the water mains pipe by a valve, wherein in the cavity a water stream shape controller is placed on a threaded connection, with a mushroom-like shape with a shaped external surface and a shaped internal surface and a stem connected by a thread with the casing, whereas the controller has within the stem an internal tunnel connected with a pipe of the venting system.

6. Macerator in accordance with the claim 1, wherein the body of the macerator tank is placed on a frame of the casing on hangers mounted each to the frame support through an elastic ring.
